(19) United States
(12) Patent Application Publication
(10) Pub. No.: US 2026/0139187 A1
(43) Pub. Date: May 21, 2026

(54) EXTRATERRESTRIAL SOIL IMPROVEMENT METHODS AS SPACE IMPROVEMENT TECHNIQUES AND A METHOD FOR GEOPOLYMER OR CEMENT PRODUCTION IN AN EXTRATERRESTRIAL ENVIRONMENT

(71) Applicants: Hamed NIROUMAND, Tehran (IR); Lech Balachowski, Gdansk (PL)

(72) Inventors: Hamed NIROUMAND, Tehran (IR); Lech Balachowski, Gdansk (PL)

(21) Appl. No.: 18/953,054

(22) Filed: Nov. 19, 2024

(51) Int. Cl. C09K 17/12; C04B 28/00; C04B 111/00; E02D 3/046; E02D 3/12

(52) U.S. Cl. CPC C09K 17/12; C04B 28/006; E02D 3/046; E02D 3/126; C04B 2111/00732

(57) ABSTRACT

A method for extraterrestrial soil improvement as space improvement techniques or lunar soil improvement methods or lunar regolith improvement techniques using ground injection, comprising preparation of a geopolymer, cement or cellulose-based binder composition, injection of a binder composition into the target soil improvement area and curing the injected binder composition. wherein at least one of the steps a) to d) is performed by a robot. Method for geopolymer or cement production in an extraterrestrial object environment, comprising mixing the raw material with an alkaline solution to create a geopolymer or with a binder composition to form a cementitious material, curing the resulting mixture, wherein at least one of the steps a) to c) is performed by a robot. Method for extraterrestrial soil improvement, involving: inserting columns of compacted regolith; or injecting a low-mobility grout; or inserting a vibrating probe.

### BACKGROUND OF THE INVENTION

### Field of the Invention

The present disclosure generally relates to extraterrestrial materials engineering, and more particularly to methods for soil improvement in an extraterrestrial environment as space improvement techniques and to a method of geopolymer or cement production using robots.

### Brief Description of the Background of the Invention Including Prior Art

As space exploration becomes a dominant scientific and technological goal worldwide, many challenges appear, many of which relate to simple and durable construction solutions applied on-site at the extraterrestrial body, for example Moon or Mars. As one of the most important elements deciding on the structural integrity of a ground construction project is foundation thereof, simple and robust soil improvement techniques have become main topics of the extraterrestrial construction as space improvement in space construction research.

One of the most popular techniques of improving the soil is adding other materials to the soil and/or mixing it together. Existing soil stabilization additives include dispersants, synthetic resins, cement, salts, alkalis and many others and are distributed in a form of a powder, a suspension, a spray or any other suitable method.

Since large-scale transport of the construction materials outside the Earth's surface and orbit poses a significant economical challenge, other solutions are being sought, such as using the on-site materials and component oxides available on the extraterrestrial body. The exploration and potential colonization of the Moon and Mars necessitate the development of robust ground improvement techniques to ensure the stability and safety of infrastructure. This will help in space construction on the Moon and Mars. The target soil area to be improved is characterized by several key soil characteristics, including soil type, shear strength, compressibility, hydraulic conductivity, organic content, plasticity index, and moisture content.

### Lunar Regolith

Lunar regolith is composed of rock fragments, mono-mineral fragments, and various kinds of glasses, including agglutinate particles, volcanic and impact spherules. It is formed primarily from meteoroid impacts that have pulverized the surface into a fine, dusty material. The regolith is highly abrasive, with jagged and angular particles due to the lack of weathering processes on the Moon. This makes it challenging to handle but also provides a rich source of silicates and other minerals for construction materials.

### Martian Soil

Martian soil consists of basaltic mineralogy, iron (hydr) oxides, amorphous material, sulfate, chloride, (per)chlorate, nitrate, carbonate, and possible organic carbon. The soil is rich in iron oxides, giving Mars its characteristic red color. The soil is loose and unconsolidated, with a high sulfur and chlorine content but depleted in carbonates. The presence of perchlorates and other salts indicates oxidative aqueous alteration processes.

U.S. Pat. No. 5,820,302 discloses a method of stabilizing soil, a method of forming a structure and a stabilization formulation for a soil aggregate base material useful for forming a structure. The soil stabilization method includes combining a soil aggregate base material with a composition, adding cement to the combination of the base material and the composition and adding water to the resulting mixture whereby sufficient water is added to the resulting mixture to hydrate the cement and thereby provide a stabilized soil aggregate matrix suitable for use in a structure. The minimum amount of cement added is 1% based on the weight of the soil aggregate base material. The composition comprises an alkali metal silicate and a water soluble divalent or trivalent cation. The amount of the cement added to the composition may be adjusted according to the composition and characteristics of the soil at the target construction site.

CN110405903A discloses lunar regolith concrete suitable for being extruded and a preparation method thereof. The lunar soil “concrete” suitable for extrusion is characterized in that the “concrete” of the lunar soil includes a lunar soil mimic, calcium silicate and water; and the calcium silicate is calculated by using the mass of the lunar soil simulant as 100 parts. The parts by mass are 45-46 parts, and the parts by mass of water are 54-55 parts.

US2014209515A1 discloses a blended regolith simulant material comprising: one part by volume of original regolith simulant material to N parts by volume of a low-density fine particulate material additive, where N is generally greater than one less than the ratio of the gravitational acceleration on the surface of the earth to the gravitational acceleration on the surface of a target extraterrestrial body and generally lies in the range obtained from the formula (F−1)−N≤ρ s(F−1)/(ρ s−Fρ b) , where F is the ratio of gravitational acceleration on earth to that on the target extraterrestrial body, ρ s is the bulk density of original regolith simulant material, and ρ b is the bulk density of the low-density fine particulate additive.

The solutions from the prior art are complex and usually require significant input of materials of Earth origin to provide the structural strength of the target soil improvement area, which drastically increases the cost of the construction project.

As explained above, there is a need for a construction material available on-site at the extraterrestrial body for construction purposes, providing expectable and repeatable results, while also not needing any additional additives to achieve such properties as well as not needing or needing a minimum amount of water in its composition, which is scarce in such environments, as well as a production method allowing a simple and high-quality production of the said material on-site. There is also a need for a method for extraterrestrial soil improvement, providing various soil improvement techniques or lunar improvement as space improvement techniques to use according to the current mechanical properties of the target soil improvement area and according to the structural needs of the construction project to be developed on the target soil improvement area.

### SUMMARY OF THE INVENTION

### Purposes of the Invention

It is an object of the present invention to provide a solution to the above mentioned problems, namely to provide a method for extraterrestrial soil improvement as space improvement techniques, requiring minimal input of materials of origin from outside of the target extraterrestrial object, maximizing the use of in-situ materials, while improving the mechanical properties of the extraterrestrial soil in an extent sufficient to prepare the target extraterrestrial soil for further development, for example for development of space expedition structures and objects in space construction. It is a further object of the invention to provide a method for geopolymer or cement production in an extraterrestrial environment, utilizing in-situ extraterrestrial materials, minimizing the need of additional materials of origin from outside of the extraterrestrial object. It is another object of the invention to provide a method for extraterrestrial soil improvement involving physical modification of the extraterrestrial soil, to provide different soil improvement method as space improvement techniques (mechanical or injection) according to the mechanical properties of the target soil improvement area, in order to achieve the best soil improvement effectiveness with minimal effort provided.

These and other objects and advantages of the present invention will become apparent from the detailed description, which follows.

### Brief Description of the Invention

The object of the invention is to provide a method for extraterrestrial soil improvement as space improvement using ground injection, characterized by comprising the following steps a)-d). Extraterrestrial soil means soil available at the surface of an extraterrestrial object, such as Moon, Mars, or any other planet or other astronomical object comprising soil.

The method according to the invention comprises the step a), including preparation of the construction site and designating the target soil improvement area.

The method according to the invention comprises the step b), including preparation of a binder composition, wherein the binder composition is a composition selected from the group consisting of: a geopolymer, a cementation material, bio cementation material and a cellulose-based composition. The binder composition typically includes aluminosilicate sources such as fly ash or metakaolin, which react with an alkaline activator like sodium hydroxide or potassium hydroxide. This reaction forms a three-dimensional network of silicate and aluminate tetrahedra, resulting in a material with high mechanical strength, low shrinkage, and excellent durability. The binder composition may comprise either a ready composition, e.g. provided from outside of the extraterrestrial object, or a composition prepared on an extraterrestrial object, using in-situ local materials like regolith. The binder composition may use different component oxides in various particle sizes of macro, micro, nano and pico. Geopolymers are synthetic materials formed by the reaction of aluminosilicate minerals with alkaline solutions. They offer a sustainable alternative to traditional cement, especially in extraterrestrial environments where local resources must be utilized.

The method according to the invention comprises the step c), including injection of the binder composition into the target soil improvement area, wherein the amount of the binder composition to inject, rate and pressure of the injection, temperature of the injection and the injection technique are selected according to the size and composition of the target soil improvement area. Injecting the binder composition into the extraterrestrial soil fills the voids and stabilizes the soil, enhancing the load-bearing capacity and reducing the permeability of the soil, making it suitable for construction. The amount of polymer injection can vary based on the specific application and the properties of the regolith. Typically, the injection amount is optimized to ensure sufficient penetration and bonding with the regolith while maintaining structural integrity. For effective stabilization and consolidation, the injection rate and pressure need to be carefully controlled. This often involves using packers or injection lances to deliver the polymer at a consistent rate and pressure suitable for the specific soil conditions. The temperature of injection is generally kept at ambient or slightly elevated levels to facilitate the curing process. Advanced techniques like computer-aided engineering (CAE) and Design of Experiments (DOE) are used to optimize parameters like amount, rate and temperature of injection to ensure a robust and efficient process.

The method according to the invention comprises the step d), including curing the injected binder composition to achieve desired extraterrestrial soil improvement effect on the target extraterrestrial soil improvement area. The method according to the invention is characterized by that at least one of the steps a) to d) is performed by a robot. A robot can be utilized, to for example drill and mix the stabilizing agents into the extraterrestrial soil, e.g. lunar or Martian soil, at various depths, or to apply the chemical grouts uniformly across the surface, or to control the jet grouting process to form precise columns.

Preferably, in the method according to the invention, the injection of the binder composition into the target soil improvement area is performed using a technique of powder or suspension spraying.

Preferably, in the method according to the invention, the injection of the binder composition into the target soil improvement area is performed using a technique of deep soil mixing, which moreover includes blending the native soil of target soil improvement area with the binder composition or other additional stabilizing agents. Other stabilizing agents include cement or other binders, which enhance the strength and stability of the soil. Blending the native regolith with stabilizing agents like cement or other binders enhances its strength and stability. Robots can drill and mix the stabilizing agents into the soil at various depths. Robots equipped with injection systems can inject the geopolymer paste into the Moon and Mars to fill voids and stabilize the soil. The use of robots for ground improvement on the Moon and Mars as “Space Improvement” offers a sustainable and efficient approach to preparing extraterrestrial surfaces for human habitation and infrastructure development. This method enhances the load-bearing capacity and reduces the permeability of the soil, making it suitable for construction.

Preferably, in the method according to the invention, injection of the binder composition into the target soil improvement area is performed using a technique of chemical grouting, which includes applying a chemical solution to permeate and solidify the target soil improvement area. Various chemical solutions can be used to permeate and solidify the lunar soils. Robots can apply the chemical grouts uniformly across the surface.

Preferably, in the method according to the invention, injection of the binder composition into the target soil improvement area is performed using a technique of jet grouting, which includes injecting high-pressure jets of grout into the target soil improvement area to create solidified columns. High-pressure jets of grout can be injected into the space soils such as regolith and lunar soils to create solidified columns. The binder composition used in the jet grouting technique typically includes a mixture of cement, water, and various additives to enhance performance. This composition is designed to provide high compressive strength, ensuring the stability and load-bearing capacity of the treated soil. It also features low permeability, which helps to reduce water infiltration and improve overall soil stability. The binder is durable, capable of withstanding environmental conditions over time, and has good workability, allowing it to be effectively injected and mixed with the in-situ soil. Additionally, the setting time of the binder is controlled to ensure proper solidification within the desired timeframe, making it a reliable choice for creating strong, stable soil columns. Robots can control the jet grouting process to form precise columns.

Preferably, in the method according to the invention, the amount of the binder composition to be injected is selected from the range of: 1-15% by weight.

Preferably, in the method according to the invention the rate of injection is selected from the range of: 0.01-5 L per minute.

Preferably, in the method according to the invention, the pressure of the injection is selected from the range of: 0.5-150 Mpa.

Preferably, in the method according to the invention, the temperature of injection is selected from the range of: 12°-45° C.

Preferably, in the method according to the invention, the binder composition includes particles of size in the range of 1 pm to 1000 μm, preferably in the range of 2 nm to 1000 nm. Range of 1 pm to 1000 μm is intended to also include particle sizes referred to as “pico”, “nano” and “micro”.

It is another object of the invention to provide a method for production of geopolymer or cementation material in an extraterrestrial object environment, comprising the following steps a) to c). Geopolymer or cementation material may also include biological additives or be based on a biological material. Extraterrestrial object can be any planet, such as Mars or other astronomical object such as Moon or an asteroid. The Moon has a very low atmospheric pressure, essentially a vacuum. For geopolymer production and other construction activities, a controlled environment with a pressure similar to Earth's atmospheric pressure (around 101.3 kPa) is typically required. The temperature on the Moon varies drastically. Daytime temperatures can reach up to 121° C. (250° F.), while nighttime temperatures can drop to −133° C. (−208° F.). For construction and geopolymer curing, maintaining a stable temperature around 17° C. (63° F.) within shaded or controlled environments is ideal. Mars has a thin atmosphere with a pressure of about 610 Pa (0.6 kPa), which is less than 1% of Earth's atmospheric pressure. For effective geopolymer production, a pressurized habitat or enclosure that simulates Earth-like conditions (around 101.3 kPa) is necessary. The average temperature on Mars is about −60° C. (−80° F.), with extremes ranging from −195° F. (−125° C.) at the poles to 70° F. (20° C.) in the summer at the equator. Space cement is essential for constructing durable infrastructure on the Moon and Mars. This cement can be produced using local materials and robotic systems.

The method according to the invention comprises the step a), including providing in-situ raw material. In-situ raw material may be for example regolith present on the surface of the Moon or Mars. Lunar regolith, primarily composed of silicates, can be processed to extract aluminosilicate minerals. Lunar regolith can be processed to extract silicates and other minerals suitable for cement production. Martian soil, with its basaltic composition, provides the necessary raw materials and a suitable source for geopolymer production. Robots can mine and process local regolith and soil to obtain the necessary minerals.

The method according to the invention comprises the step b), including mixing the raw material with an alkaline solution to create a geopolymer or with a binder composition to form a cementitious material. The alkaline solution acts as an activator and may comprise for example sodium silicate or sodium hydroxide. The extracted minerals are mixed with an alkaline activator (e.g., sodium silicate) to form a geopolymer or cement paste.

The method according to the invention comprises the step c), including curing the resulting mixture at the temperature in range of 5-30° C. for 1-100 h to achieve the desired mechanical properties of the mixture. The curing duration can vary based on the specific conditions, lunar soil/regolith layers and component oxides used. The method according to the invention is characterized by that at least one of the steps a) to c) is performed by a robot.

Preferably, in the method according to the invention, the curing temperature is selected from the range of 10-25° C., preferably the curing temperature is around 20° C.

Preferably, in the method according to the invention, the particle size of said geopolymer or cementation material is in range of 1 pm to 1000 μm. Such particle size can be achieved for example by means of a ball mill. Range of 1 pm to 1000 μm is intended to also include particle sizes referred to as “pico”, “nano” and “micro”.

Preferably, in the method according to the invention, the amount of the in-situ raw material ranges from 60% to 95% of the mixture obtained in step b). The amount of the raw material is selected depending on the specific technique and materials involved.

It is another object of the invention to provide a method for extraterrestrial soil improvement using physical modification of the soil, involving at least one of the following operations a) to g). Physical modification of the soil can be achieved by mechanical techniques to improve its properties. These methods can be effectively implemented using robotic systems. By leveraging local materials to produce geopolymers and space cement, and employing mechanical techniques, we can ensure the stability and safety of future lunar and Martian colonies.

The method according to the invention may involve the operation a) of inserting stone columns of compacted regolith into the extraterrestrial soil. Inserting columns of compacted regolith into the soil improves the load-bearing capacity and drainage properties of the soil.

The method according to the invention may involve the operation b) of injecting a low-mobility grout into the extraterrestrial soil. By injecting a low-mobility grout it is possible to displace and compact the soil, thereby increasing its density and strength.

The method according to the invention may involve the operation c) of inserting a vibrating probe into the extraterrestrial soil to compact the regolith and create columns of dense material. The resulting columns may be for example columns of lunar material or regolith material. The columns can also be first prepared/compacted outside the ground and then inserted into the ground, preferably using robots. Robots can compact lunar soils or drill and place and compact macro-sized lunar soils on the surface as “space columns” or “lunar columns” without injection.

The method according to the invention may involve the operation d) of installing vertical drains to provide pathways for trapped gases and moisture to escape.

The method according to the invention may involve the operation e) of circulating a coolant through pipes embedded in the extraterrestrial soil to freeze and stabilize it.

The method according to the invention may involve the operation f) of excavating weak or unsuitable extraterrestrial soils and replacing it with stronger, more stable material.

The method according to the invention may involve the operation g) of using vibrating probes to compact the extraterrestrial soil.

In the method according to the invention, the choice of operations a) to g) to use for extraterrestrial soil improvement is made depending on the mechanical properties of the target soil improvement area. The method according to the invention is characterized by that the method involves using a robot. In the case of the operation of inserting columns, robots can drill holes and place stone aggregates into the soil, compacting them to form stable columns.
In the case of compaction grout operation, robots can precisely inject the grout into targeted areas.
In the case of vibrating probe operation, robots can operate the vibrating probes to achieve uniform compaction.
In the case of drains installation operation, robots can install the drains at specified intervals.
In the case of soil freezing operation, robots can install and monitor the cooling system.
In the case of remove and replace operation, robots can perform the excavation and replacement process efficiently.
Additionally, biological additives may also be used as soil additives in the extraterrestrial soil improvement methods described therein.

### BRIEF DESCRIPTION OF THE DRAWINGS

These aims together with other objects and advantages which will become subsequently apparent reside in the details of the construction and operation as more fully hereinafter described and claimed, reference being made to the accompanying drawings forming a part hereof, wherein the same numerals refer to the same parts throughout.

In drawings

FIG. 1 illustrates schematically a side view, including a cross section of the target soil improvement area, of the implementation of the injection step c) of the method for extraterrestrial soil improvement using ground injection, using a deep soil mixing operation,

FIG. 2 illustrates schematically a side view, including a cross section of the target soil improvement area, of the implementation of the injection step c) of the method for extraterrestrial soil improvement using jet grouting operation,

FIG. 3 illustrates schematically a side view, including a cross section of the target soil improvement area, of the implementation of the injection step c) of the method for extraterrestrial soil improvement using stone column operation,

FIG. 4 illustrates schematically a side view, including a cross section of the target soil improvement area, of the implementation of the injection step c) of the method for extraterrestrial soil improvement using remove and replace operation.

### DETAILED DESCRIPTION OF THE INVENTION

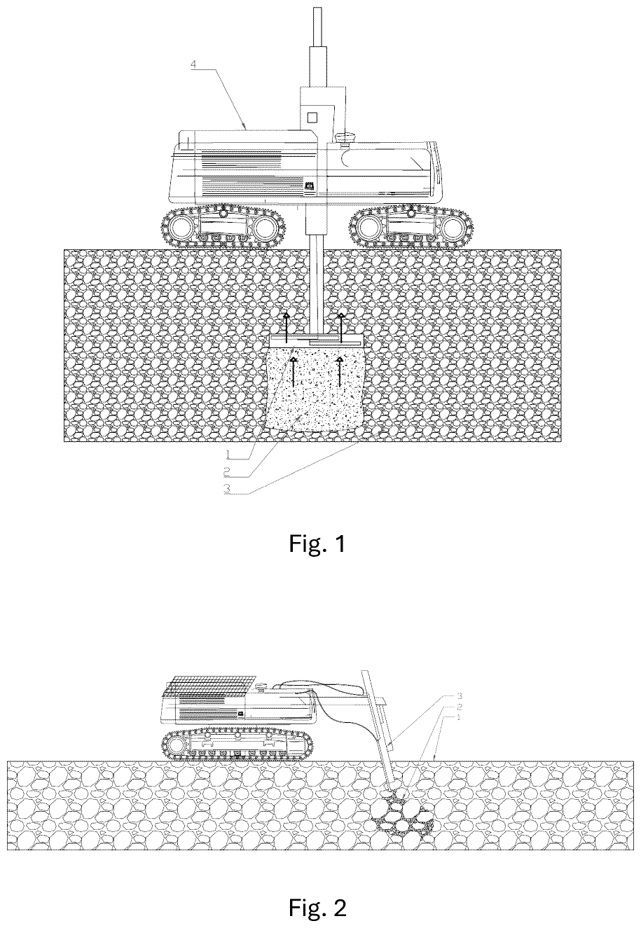

Referring to the drawing, FIG. 1 shows schematically a side view, including a cross section of the target soil improvement area, of the implementation of the injection step c) of the method for extraterrestrial soil improvement using ground injection, using a deep soil mixing operation. In this embodiment of the method, the extraterrestrial target soil improvement area is located on the Moon. The construction site is first prepared, and the target soil improvement area is designated. In this case, the target soil improvement area is characterized by the following soil characteristics: shear strength: 15 kPa, compressibility: low, hydraulic conductivity: 10⁻¹⁰ m/s, organic content: none, plasticity index: non-plastic, moisture content: none. Basing on this characteristics of the soil, the deep soil mixing operation is used as the injection operation of the method. Next, basing on the acquired characteristics of the soil, the binder composition is provided as a geopolymer material. Then, a robot 4 is provided to perform the injection step of the method. The robot 4 in this embodiment is a remotely-operated double-tracked vehicle, provided with a drilling and mixing equipment 1, capable of blending the native soil with the binder composition provided. Basing on the already known characteristics of the soil, the amount of the binder composition is selected as 10% by weight, the rate of the injection is selected as 1 L per minute, the temperature of the injection is selected as 20° C. and the pressure of the injection is selected as 100 Mpa. The robot 4 drills into the target soil improvement area 3 and mixes the soil while adding the binder composition at the earlier specified parameters, forming the improved extraterrestrial soil 2. The robot 4 then extracts the equipment 1 from the soil and the above steps are repeated at the next location. After the deep soil mixing operation, the following changes occur to the target soil improvement area: shear strength: increases as soil is mixed with stabilizing agents, compressibility: decreases due to stabilizers, hydraulic conductivity: decreases as the mixture becomes less permeable, organic content: no significant change, plasticity index: may increase, moisture content: increases temporarily during mixing.

FIG. 2 shows a side view, including a cross section of the target soil improvement area, of the embodiment of the injection step c) of the method for extraterrestrial soil improvement using jet grouting operation. This embodiment of the method is analogue to the embodiment represented by the FIG. 1, with the following differences. The target soil improvement area is located on Mars. The target soil improvement area is characterized by the following soil characteristics: shear strength: 15 kPa, compressibility: Moderate (due to varying density and porosity), hydraulic conductivity: 10⁻⁹ m/s, organic content: trace amounts, plasticity index: low to moderate, moisture content: very low. Basing on this characteristics of the soil, the jet grouting operation is used as the injection operation of the method. The binder composition is provided as a cementation material. The robot 4 in this embodiment is a remotely-operated single-tracked vehicle, provided with a drilling and injection equipment 1, capable of injecting high-pressure jets of grout into the target soil improvement area to create solidified columns. The amount of the binder composition is selected as 12% by weight, the rate of the injection is selected as 4.5 L per minute, the temperature of the injection is selected as 30° C. and the pressure of the injection is selected as 140 Mpa. The robot 4 drills into the target soil improvement area 3 based on desired depth, and injects the binding composition into the soil at the earlier specified parameters, forming solidified columns, leading to the improvement of the stability of the target extraterrestrial soil improvement area 2. After the jet grouting operation, the following changes occur to the target soil improvement area: shear strength: increases significantly as the soil is mixed with cementitious materials, compressibility: decreases due to the addition of grout, hydraulic conductivity: decreases as the grout fills voids, organic content: no significant change, plasticity index: may increase slightly, moisture content: increases temporarily during the process.

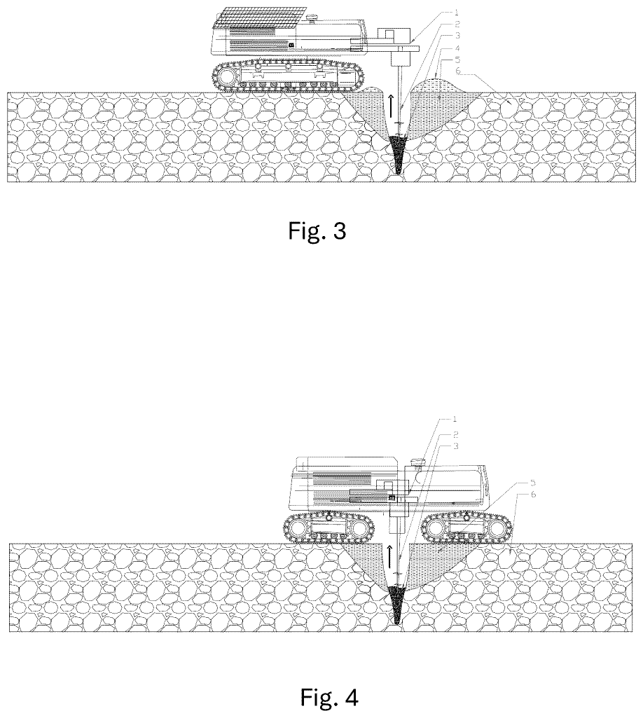

FIG. 3 shows a side view, including a cross section of the target soil improvement area, of the embodiment of the injection step c) of the method for extraterrestrial soil improvement using stone column operation. This embodiment of the method is analogue to the embodiment represented by the FIG. 2, with the following differences. Basing on the characteristics of the soil, the stone column operation is used as the injection operation of the method. The binder composition is provided as a cellulose-based composition. The robot 4 in this embodiment is a remotely-operated single-tracked vehicle, provided with a injection equipment 1. The amount of the binder composition is selected as 2% by weight, the rate of the injection is selected as 0.5 L per minute, the temperature of the injection is selected as 13° C. and the pressure of the injection is selected as 4 Mpa. The robot 4 drills into the target soil improvement area 3 and injects the binding composition into the soil at the earlier specified parameters, forming solidified columns, leading to the improvement of the stability of the target extraterrestrial soil improvement area 2. After the stone column operation, the following changes occur to the target soil improvement area: shear strength: increases due to the addition of stone columns, compressibility: decreases as the columns provide support, hydraulic conductivity: may increase locally, organic content: no significant change, plasticity index: no significant change, moisture content: no significant change.

FIG. 4 shows a side view, including a cross section of the target soil improvement area, of the embodiment of the injection step c) of the method for extraterrestrial soil improvement using remove and replace operation. This embodiment of the method is analogue to the embodiment represented by the FIG. 1, with the following differences. Basing on the characteristics of the soil, the remove and replace operation is used as the injection operation of the method. The binder composition is provided as a geopolymer composition. The robot 4 in this embodiment is a remotely-operated single-tracked vehicle, provided with a drilling equipment 1, capable of drilling the soil and removing it out of the target soil improvement area. The amount of the binder composition is selected as 5% by weight, the rate of the injection is selected as 3.5 L per minute, the temperature of the injection is selected as 40° C. and the pressure of the injection is selected as 40 Mpa. The robot 4 drills into the target soil improvement area 3 and removes the lunar regolith out of the target soil improvement area. Then, the soil is mixed with the binding composition and the resulting mixture is placed back into the resulting hole in the target soil improvement area, leading to the improvement of the stability of the target extraterrestrial soil improvement area 2.

In one embodiment according to the method for production of geopolymer or cementation material in an extraterrestrial object, the extraterrestrial object is Mars and the material to be produced is selected as geopolymer. First, the in-situ raw material is provided in form of 2 tons of soil from the surface of the Mars. The in-situ raw material is collected using a remote-operated collector robot. Then, the acquired material is mixed with an alkaline solution, which in this case is sodium hydroxide. The mixing is performed by a remote-operated mixing robot. The resulting geopolymer mixture is then cured for 60 h to achieve the desired mechanical properties of the mixture. The curing temperature is 20° C. The particle size of the resulting geopolymer mixture is 200 nm.

Another embodiment according to the method for production of geopolymer or cementation material is analogue to the previous embodiment, with the following differences. The extraterrestrial object is Moon. The material to be produced is selected as cementation material. The in-situ raw material is 2 tons of lunar regolith. The raw material is mixed with a binder composition. The resulting cementation material mixture is then cured for 90 h. The curing temperature is 12° C. The particle size of the resulting cementation material mixture is 500 pm.

1. A method for extraterrestrial soil improvement as space improvement using ground injection, comprising the following steps:
a) preparation of the construction site and designation of the target soil improvement area,
b) preparation of a binder composition, wherein the binder composition is a composition selected from the group consisting of: geopolymer, cementation material, bio cementation material and cellulose-based composition,
c) injection of the binder composition into the target soil improvement area, wherein the amount of the binder composition to inject, rate and pressure of the injection, temperature of the injection and the injection technique are selected according to the size and composition of the target soil improvement area,
d. curing the injected binder composition to achieve desired extraterrestrial soil improvement effect on the target extraterrestrial soil improvement area,
wherein at least one of the steps a) to d) is performed by a robot.

2. The method according to claim 1, wherein the injection of the binder composition into the target soil improvement area is performed using a technique of powder or suspension spraying.

3. The method according to claim 1, wherein the injection of the binder composition into the target soil improvement area is performed using a technique of deep soil mixing, which moreover includes blending the native soil of target soil improvement area with the binder composition or other additional stabilizing agents.

4. The method according to claim 1, wherein the injection of the binder composition into the target soil improvement area is performed using a technique of chemical grouting, which includes applying a chemical solution to permeate and solidify the target soil improvement area.

5. The method according to claim 1, wherein the injection of the binder composition into the target soil improvement area is performed using a technique of jet grouting, which includes injecting high-pressure jets of grout into the target soil improvement area to create solidified columns.

6. The method according to claim 1, wherein the amount of the binder composition to be injected is selected from the range of: 1-15% by weight.

7. The method according to claim 1, wherein the rate of the injection is selected from the range of: 0.01-5 L per minute.

8. The method according to claim 1, wherein the pressure of the injection is selected from the range of: 0.5-150 Mpa.

9. The method according to claim 1, wherein the temperature of injection is selected from the range of: 12°-45° C.

10. The method according to claim 1, wherein the binder composition includes particles of size in the range of 1 pm to 1000 μm, preferably in the range of 2 nm to 1000 nm.

11. A method for production of geopolymer or cementation material in an extraterrestrial object environment, comprising the steps of:
a) providing in-situ raw material,
b) mixing the raw material with an alkaline solution to create geopolymer or with a binder composition to form a cementitious material,
c) curing the resulting mixture at the temperature in range of 5-30°C for 1-100 h to achieve the desired mechanical properties of the mixture,
wherein at least one of the steps a) to c) is performed by a robot.

12. The method according to claim 11, wherein the curing temperature is selected from the range of 10-25°C, preferably the curing temperature is around 20°C.

13. The method according to claim 11, wherein the particle size of said geopolymer or cementation material is in range of 1 pm to 1000 μm.

14. The method according to claim 11, wherein the amount of the in-situ raw material ranges from 60% to 95% of the mixture obtained in step b).

15. A method for extraterrestrial soil improvement using physical modification of the soil, involving at least one of the following operations:
a) inserting stone columns of compacted regolith into the extraterrestrial soil;
b) injecting a low-mobility grout into the extraterrestrial soil;
c) inserting a vibrating probe into the extraterrestrial soil to compact the regolith and create columns of dense material;
d) installing vertical drains to provide pathways for trapped gases and moisture to escape;
e) circulating a coolant through pipes embedded in the extraterrestrial soil to freeze and stabilize it;
f) excavating weak or unsuitable extraterrestrial soils and replacing it with stronger, more stable material;
g) using vibrating probes to compact the extraterrestrial soil,
wherein the choice of operations a) to g) to use for extraterrestrial soil improvement is made depending on the mechanical properties of the target soil improvement area and wherein the method involves using a robot.
